(19) United States
(12) Patent Application Publication
(10) Pub. No.: US 2014/0208543 A1
(43) Pub. Date: Jul. 31, 2014

(54) MAGNETIC HINGE SYSTEM

(71) Applicant: Correlated Magnetics Research, LLC., Huntsville, AL (US)

(72) Inventors: Larry W. Fullerton, New Hope, AL (US); Mark D. Roberts, Huntsville, AL (US); Hamilton G. Moore, Decatur, AL (US)

(73) Assignee: Correlated Magnetics Research, LLC., Huntsville, AL (US)

(21) Appl. No.: 14/198,249

(22) Filed: Mar. 5, 2014

Related U.S. Application Data
(63) Continuation-in-part of application No. 14/035,818, filed on Sep. 24, 2013.
Application No. 14/035,818 is a continuation-in-part of application No. 13/959,649, filed on Aug. 5, 2013, now Pat. No. 8,692,637.
Application No. 13/959,649 is a continuation-in-part of application No. 13/759,695, filed on Feb. 5, 2013, now Pat. No. 8,502,630.
Application No. 13/759,695 is a continuation of application No. 13/481,554, filed on May 25, 2012, now Pat. No. 8,368,495.
Application No. 13/481,554 is a continuation-in-part of application No. 13/351,203, filed on Jan. 16, 2012, now Pat. No. 8,314,671.
Application No. 13/351,203 is a continuation of application No. 13/157,975, filed on Jun. 10, 2011, now Pat. No. 8,098,122.
Application No. 13/157,975 is a continuation of application No. 12/952,391, filed on Nov. 23, 2010, now Pat. No. 7,961,069.
Application No. 12/952,391 is a continuation of application No. 12/478,911, filed on Jun. 5, 2009, now Pat. No. 7,843,295.
Application No. 12/952,391 is a continuation of application No. 12/478,950, filed on Jun. 5, 2009, now Pat. No. 7,843,296.
Application No. 12/478,950 is a continuation of application No. 12/478,969, filed on Jun. 5, 2009, now Pat. No. 7,843,297.
Application No. 12/478,969 is a continuation of application No. 12/479,013, filed on Jun. 5, 2009, now Pat. No. 7,839,247.
Application No. 12/478,950 is a continuation-in-part of application No. 12/476,952, filed on Jun. 2, 2009, now Pat. No. 8,179,219.
Application No. 12/952,391 is a continuation-in-part of application No. 12/476,952, filed on Jun. 2, 2009, now Pat. No. 8,179,219.
Application No. 12/478,969 is a continuation-in-part of application No. 12/476,952, filed on Jun. 2, 2009, now Pat. No. 8,179,219.
Application No. 12/479,013 is a continuation-in-part of application No. 12/476,952, filed on Jun. 2, 2009, now Pat. No. 8,179,219.
Application No. 12/476,952 is a continuation-in-part of application No. 12/322,561, filed on Feb. 4, 2009, now Pat. No. 8,115,581.
Application No. 12/322,561 is a continuation-in-part of application No. 12/358,423, filed on Jan. 23, 2009, now Pat. No. 7,868,721.
Application No. 12/358,423 is a continuation-in-part of application No. 12/123,718, filed on May 20, 2008, now Pat. No. 7,800,471.
(60) Provisional application No. 61/851,614, filed on Mar. 11, 2013.
(60) Provisional application No. 61/851,275, filed on Mar. 6, 2013.
(60) Provisional application No. 61/744,342, filed on Sep. 24, 2012.
(60) Provisional application No. 61/519,664, filed on May 25, 2011.
(60) Provisional application No. 61/123,019, filed on Apr. 4, 2008.

(51) Int. Cl. E05D 7/00

(52) U.S. Cl. CPC E05D 7/00
USPC 16/273

(57) ABSTRACT

A magnetic hinge system includes a first component that is associated with a first object, a second component that is associated with a second object, and an axle. The first component includes a first hole and a first magnetic structure having a first plurality of magnetic source regions having a first polarity pattern. The second component includes a second hole and a second magnetic structure having a second plurality of magnetic source regions having a second polarity pattern complementary to said first polarity pattern. The axle can be inserted into the first hole and the second hole such that the first and second magnetic structures face each other across an interface boundary, where the first polarity pattern and the second polarity pattern are in accordance with a cyclic implementation of a code of length N that has a cyclic correlation function having a single peak and a plurality of off peaks per code modulo.

### RELATED APPLICATIONS

This application is a continuation in part of non-provisional application Ser. No. 14/035,818, titled: “Magnetic Structures and Methods for Defining Magnetic Structures Using One-Dimensional Codes” filed Sep. 24, 2013 by Fullerton et al. and claims the benefit under 35 USC 119(e) of provisional application 61/851,275, titled “Magnetic Hinge System”, filed Mar. 11, 2013, by Fullerton et al.; Ser. No. 14/035,818 is a continuation in part of non-provisional application Ser. No. 13/959,649, titled: “Magnetic Device Using Non Polarized Magnetic Attraction Elements” filed Aug. 5, 2013 by Richards et al. and claims the benefit under 35 USC 119(e) of provisional application 61/744,342, titled “Magnetic Structures and Methods for Defining Magnetic Structures Using One-Dimensional Codes”, filed Sep. 24, 2012 by Roberts; Ser. No. 13/959,649 is a continuation in part of non-provisional application Ser. No. 13/759,695, titled: “System and Method for Defining Magnetic Structures” filed Feb. 5, 2013 by Fullerton et al., which is a continuation of application Ser. No. 13/481,554, titled: “System and Method for Defining Magnetic Structures”, filed May 25, 2012, by Fullerton et al., U.S. Pat. No. 8,368,495; which is a continuation-in-part of Non-provisional application Ser. No. 13/351,203, titled “A Key System For Enabling Operation Of A Device”, filed Jan. 16, 2012, by Fullerton et al., U.S. Pat. No. 8,314,671; Ser. No. 13/481,554 also claims the benefit under 35 USC 119(e) of provisional application 61/519,664, titled “System and Method for Defining Magnetic Structures”, filed May 25, 2011 by Roberts et al.; Ser. No. 13/351,203 is a continuation of application Ser. No. 13,157,975, titled “Magnetic Attachment System With Low Cross Correlation”, filed Jun. 10, 2011, by Fullerton et al., U.S. Pat. No. 8,098,122, which is a continuation of application Ser. No. 12/952,391, titled: “Magnetic Attachment System”, filed Nov. 23, 2010 by Fullerton et al., U.S. Pat. No. 7,961,069; which is a continuation of application Ser. No. 12/478,911, titled “Magnetically Attachable and Detachable Panel System” filed Jun. 5, 2009 by Fullerton et al., U.S. Pat. No. 7,843,295; Ser. No. 12/952,391 is also a continuation of application Ser. No. 12/478,950, titled “Magnetically Attachable and Detachable Panel Method,” filed Jun. 5, 2009 by Fullerton et al., U.S. Pat. No. 7,843,296; Ser. No. 12/952,391 is also a continuation of application Ser. No. 12/478,969, titled “Coded Magnet Structures for Selective Association of Articles,” filed Jun. 5, 2009 by Fullerton et al., U.S. Pat. No. 7,843,297; Ser. No. 12/952,391 is also a continuation of application Ser. No. 12/479,013/titled “Magnetic Force Profile System Using Coded Magnet Structures,” filed Jun. 5, 2009 by Fullerton et al., U.S. Pat. No. 7,839,247; the preceding four applications above are each a continuation-in-part of Non-provisional application Ser. No. 12/476,952 filed Jun. 2, 2009, by Fullerton et al., titled “A Field Emission System and Method”, which is a continuation-in-part of Non-provisional application Ser. No. 12/322,561, filed Feb. 4, 2009 by Fullerton et al., titled “System and Method for Producing an Electric Pulse”, which is a continuation-in-part application of Non-provisional application Ser. No. 12/358,423, filed Jan. 23, 2009 by Fullerton et al., titled “A Field Emission System and Method”, which is a continuation-in-part application of Non-provisional application Ser. No. 12/123,718, filed May 20, 2008 by Fullerton et al., titled “A Field Emission System and Method”, U.S. Pat. No. 7,800,471, which claims the benefit under 35 USC 119(e) of U.S. Provisional Application Ser. No. 61/123,019, filed Apr. 4, 2008 by Fullerton, titled “A Field Emission System and Method”. The applications and patents listed above are incorporated by reference herein in their entirety.

### FIELD OF THE INVENTION

The present invention relates generally to a magnetic hinge system. More particularly, the present invention relates to a system for magnetic attachment involving a magnetic hinge having complementary magnetic structures.

### SUMMARY OF THE INVENTION

A magnetic hinge system includes a first component associated with a first object, a second component associated with a second object, and an axle. The first component includes a first hole and a first magnetic structure having a first plurality of magnetic source regions having a first polarity pattern and the second component includes a second hole and a second magnetic structure having a second plurality of magnetic source regions having a second polarity pattern complementary to said first polarity pattern. The axle can be inserted into the first hole and the second hole such that the first and second magnetic structures face each other across an interface boundary, wherein the first polarity pattern and said second polarity pattern are in accordance with a cyclic implementation of a code of length N that has a cyclic correlation function having a single peak and a plurality of off peaks per code modulo.

The magnetic hinge system can be configured to have low friction between the first and second components.

The first and second polarity patterns can be irregular polarity patterns.

The first and second magnetic structures can produce a peak attract force when in a complementary rotational alignment position.

The complementary rotational alignment position can correspond to a desired alignment of said first component and said second component.

The complementary rotational alignment position can correspond to a closed position of door.

The first and second magnetic structures can produce an off-peak force that is an attract force less than the peak attract force when the male component has been rotated relative to the female component plus or minus 360/N degrees from the complementary rotational alignment position and said cyclic implementation of the code includes only one code modulo of the code.

The first and second magnetic structures can produce an off-peak force that is a substantially zero force when the male component has been rotated relative to the female component plus or minus 360/N degrees from the complementary rotational alignment position and said cyclic implementation of the code includes only one code modulo of the code.

The first and second magnetic structures can produce an off-peak force that is a repel force when the male component has been rotated relative to the female component plus or minus 360/N degrees from the complementary rotational alignment position and said cyclic implementation of the code includes only one code modulo of the code,

The code can be a Barker code.

Each symbol of the code can be implemented with one of a region having a first polarity or a region having a second polarity.

Each symbol of the code can be implemented with an irregular polarity pattern.

Each symbol of the code can be a Barker code.

Each symbol of the code can be implemented with alternating polarity regions, where one polarity region can be rotated relative to another polarity region and/or polarities of opposing regions of the first and second magnetic structures can be exchanged.

The first component can be integrated into the first object.

The second component can be integrated into the second object.

At least one of the first magnetic structure or the second magnetic structure can be ring shaped.

At least one of the first magnetic structure or the second magnetic structure can include a plurality of discrete magnets.

### BRIEF SUMMARY OF THE DRAWINGS

The present invention is described with reference to the accompanying drawings. In the drawings, like reference numbers indicate identical or functionally similar elements. Additionally, the left-most digit(s) of a reference number identifies the drawing in which the reference number first appears.

FIG. 1 depicts an exemplary first component and an exemplary second component in accordance with the invention.

FIG. 2A depicts an exemplary first magnetic structure having thirteen magnetic sources having a first polarity pattern corresponding to cyclic implementation of a Barker 13 code and an exemplary second magnetic structure having thirteen magnetic sources having a second polarity pattern that is complementary to the first polarity pattern.

FIG. 2B depicts the cyclic correlation function of the first magnetic structure of FIG. 2A rotating relative to the second magnetic structure of FIG. 2B.

FIGS. 3A-3C depict assembly of a first exemplary magnetic hinge system in accordance with the invention.

FIGS. 4A and 4B depict provide two views of another exemplary first component in accordance with the invention.

FIG. 4C depicts another exemplary second component in accordance with the invention.

FIG. 5A depicts a top view of an exemplary first ring-shaped magnetic structure having first magnetic source regions having a first polarity pattern in accordance with a Barker 7 code and an exemplary second ring-shaped magnetic structure having second magnetic source regions having a second polarity pattern that is complementary to the first polarity pattern.

FIG. 5B depicts the cyclic correlation function of the first magnetic structure of FIG. 5A rotating relative to the second magnetic structure of FIG. 5B.

FIG. 6A depicts assembly of a second exemplary magnetic hinge system in accordance with the invention.

FIGS. 6B-6D depict various views of the second exemplary magnetic hinge system.

FIG. 7 depicts exemplary polarity patterns for printed magnetic sources into complementary ring magnet structures in accordance with a cyclic implementation of a Barker 7 code.

FIG. 8A depicts an exemplary cyclic correlation function of complementary magnetic structures having polarity patterns in accordance with a Barker 3 code.

FIG. 8B depicts an exemplary cyclic correlation function of complementary magnetic structures having polarity patterns in accordance with a Barker 4 code.

FIG. 8C depicts an exemplary cyclic correlation function of complementary magnetic structures having polarity patterns in accordance with a Barker 5 code.

FIG. 8D depicts t an exemplary he cyclic correlation function of complementary magnetic structures having polarity patterns in accordance with a Barker 11 code.

FIG. 9A depicts exemplary complementary Barker 4 coded magnetic structures where each symbol of the Barker 4 code corresponds to alternating polarity arc segments that together form five concentric Barker 4 coded circles.

FIG. 9B depicts exemplary magnetic structure polarity pattern designs where the starting point of the Barker 4 code sequence is rotated 90° with each successive concentric circle.

FIG. 9C depicts exemplary shifting of the starting point for each Barker 4 pattern 180 degrees for each odd concentric circle.

FIG. 9D depicts exemplary shifting of the odd polarity quadrant 180 degrees with each circle and reverses the polarity of the third and fourth circles.

FIG. 9E illustrates how the arc segments of each quadrant can be subdivided into alternating polarity portions.

FIG. 9F illustrates how portions of the two magnetic structures can be used to provide a bias force.

FIG. 10A depicts exemplary complementary magnetic structures comprising two halves of alternating polarity arc segments.

FIG. 10B depicts complementary magnetic structure comprising four alternating polarity quadrants of alternating polarity arc segments.

FIG. 10C depicts complementary magnetic structures where the outer four circles comprise eight alternating polarity octants of alternating polarity arc segments and inner most circles that provide an attract bias force regardless of rotational alignment.

### DETAILED DESCRIPTION OF THE INVENTION

The present invention will now be described more fully in detail with reference to the accompanying drawings, in which the preferred embodiments of the invention are shown. This invention should not, however, be construed as limited to the embodiments set forth herein; rather, they are provided so that this disclosure will be thorough and complete and will fully convey the scope of the invention to those skilled in the art.

Certain described embodiments may relate, by way of example but not limitation, to systems and/or apparatuses comprising magnetic structures, magnetic and non-magnetic materials, methods for using magnetic structures, magnetic structures produced via magnetic printing, magnetic structures comprising arrays of discrete magnetic elements, combinations thereof, and so forth. Example realizations for such embodiments may be facilitated, at least in part, by the use of an emerging, revolutionary technology that may be termed correlated magnetics. This revolutionary technology referred to herein as correlated magnetics was first fully described and enabled in the co-assigned U.S. Pat. No. 7,800,471 issued on Sep. 21, 2010, and entitled “A Field Emission System and Method”. The contents of this document are hereby incorporated herein by reference. A second generation of a correlated magnetic technology is described and enabled in the co-assigned U.S. Pat. No. 7,868,721 issued on Jan. 11, 2011, and entitled “A Field Emission System and Method”. The contents of this document are hereby incorporated herein by reference. A third generation of a correlated magnetic technology is described and enabled in the co-assigned U.S. Pat. No. 8,179,219, issued May 15, 2012, and entitled “A Field Emission System and Method”. The contents of this document are hereby incorporated herein by reference. Another technology known as correlated inductance, which is related to correlated magnetics, has been described and enabled in the co-assigned U.S. Pat. No. 8,115,581 issued on Feb. 14, 2012, and entitled “A System and Method for Producing an Electric Pulse”. The contents of this document are hereby incorporated by reference.

Material presented herein may relate to and/or be implemented in conjunction with multilevel correlated magnetic systems and methods for producing a multilevel correlated magnetic system such as described in U.S. Pat. No. 7,982,568 issued Jul. 19, 2011 which is all incorporated herein by reference in its entirety. Material presented herein may relate to and/or be implemented in conjunction with energy generation systems and methods such as described in U.S. patent application Ser. No. 13/184,543 filed Jul. 17, 2011, which is all incorporated herein by reference in its entirety. Such systems and methods described in U.S. Pat. No. 7,681,256 issued Mar. 23, 2010, U.S. Pat. No. 7,750,781 issued Jul. 6, 2010, U.S. Pat. No. 7,755,462 issued Jul. 13, 2010, U.S. Pat. No. 7,812,698 issued Oct. 12, 2010, U.S. Pat. Nos. 7,817,002, 7,817,003, 7,817,004, 7,817,005, and 7,817,006 issued Oct. 19, 2010, U.S. Pat. No. 7,821,367 issued Oct. 26, 2010, U.S. Pat. Nos. 7,823,300 and 7,824,083 issued Nov. 2, 2011, U.S. Pat. No. 7,834,729 issued Nov. 16, 2011, U.S. Pat. No. 7,839,247 issued Nov. 23, 2010, U.S. Pat. Nos. 7,843,295, 7,843,296, and 7,843,297 issued Nov. 30, 2010, U.S. Pat. No. 7,893,803 issued Feb. 22, 2011, U.S. Pat. Nos. 7,956,711 and 7,956,712 issued Jun. 7, 2011, U.S. Pat. Nos. 7,958,575, 7,961,068 and 7,961,069 issued Jun. 14, 2011, U.S. Pat. No. 7,963,818 issued Jun. 21, 2011, and U.S. Pat. Nos. 8,015,752 and 8,016,330 issued Sep. 13, 2011, and U.S. Pat. No. 8,035,260 issued Oct. 11, 2011 are all incorporated by reference herein in their entirety.

In accordance with one aspect of the invention, a magnetic hinge system comprises a first component and a second component, where the first component can be rotated relative to the second component. The first component comprises a first magnetic structure having a first plurality of magnetic source regions having a first polarity pattern. The second component comprises a second magnetic structure having a second plurality of magnetic source regions having a second polarity pattern complementary to said first polarity pattern. The first component and second component are configured such that an axle can be inserted into a hole within the first component and a hole of the second component such that the first and second magnetic structures face each other across an interface boundary. Under one arrangement, the interface boundary is configured to have low friction between the first and second components.

The first and second polarity patterns may be in accordance with a cyclic implementation of a code of length N having a cyclic correlation function having a single peak and a plurality of off peaks per code modulo. The first and second magnetic structures produce a peak attract force when in a complementary rotational alignment position. The first and second magnetic structures produce an off-peak force that is one of an attract force less than the peak attract force, a substantially zero force, or a repel force when the male component has been rotated relative to the female component plus or minus 360/N degrees from the complementary rotational alignment position. The first and second magnetic structure produce substantially the same off-peak force when the male component has been rotated relative to the female component between plus 360/N degrees from the complementary rotational alignment position and minus 360/N degrees from the complementary rotational alignment position.

Typically N is greater than 2, but N can be 2.

Under one arrangement, the first and second polarity patterns are irregular polarity patterns. Under such an arrangement, the code can be a Barker code having a length greater than 2.

Under another arrangement. Each symbol of the code can be implemented with a single polarity region, with alternating polarity regions where the alternating polarity regions can be arc segments that form concentric circles, or with an irregular polarity pattern such as a Barker code. The arc segments can also be subdivided into smaller arc segments having a polarities within a given symbol portion that is part of a given concentric circle. One concentric circle can be rotated relative to another concentric circle and the polarities of opposing concentric circles of the two magnetic structures can be exchanged.

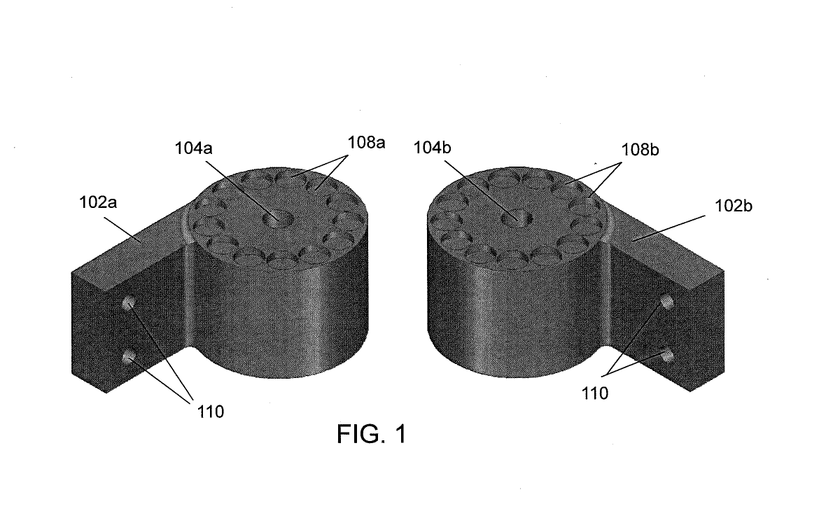

FIG. 1 depicts a first exemplary first component 102a and a first exemplary second component 102b, which could be made of plastic or any other desired material. The first component 102a has a first hole 104a for accepting an axle (not shown) and thirteen second holes 108a for accepting a first magnetic structure comprising thirteen magnets (not shown). The second component 102b has a third hole 104b for accepting the axle and has thirteen fourth holes 108b for accepting a second magnetic structure comprising thirteen magnets (not shown).

The first component 102a and/or the second component 102b may include optional holes 110, for example counter-sunk holes, enabling attachment to objects (e.g., a cabinet door, a cabinet) using screws, nails, etc. Alternatively or additionally, either or both of the first component 102a and second component 102b may have an adhesive on their back side (i.e., the sides opposite the flat faces shown). Such an adhesive may have a protective layer that can be removed to expose the adhesive at the time of installation. Furthermore, the first component 102a or the second component 102b could be integrated into an object.

One skilled in the art will understand that the first and second magnetic structures can be placed into the first and second components in such a way that their peak attach force rotational alignment position corresponds to a desired alignment of the hinges, for example, corresponding to a closed position of an object such as a cabinet door.

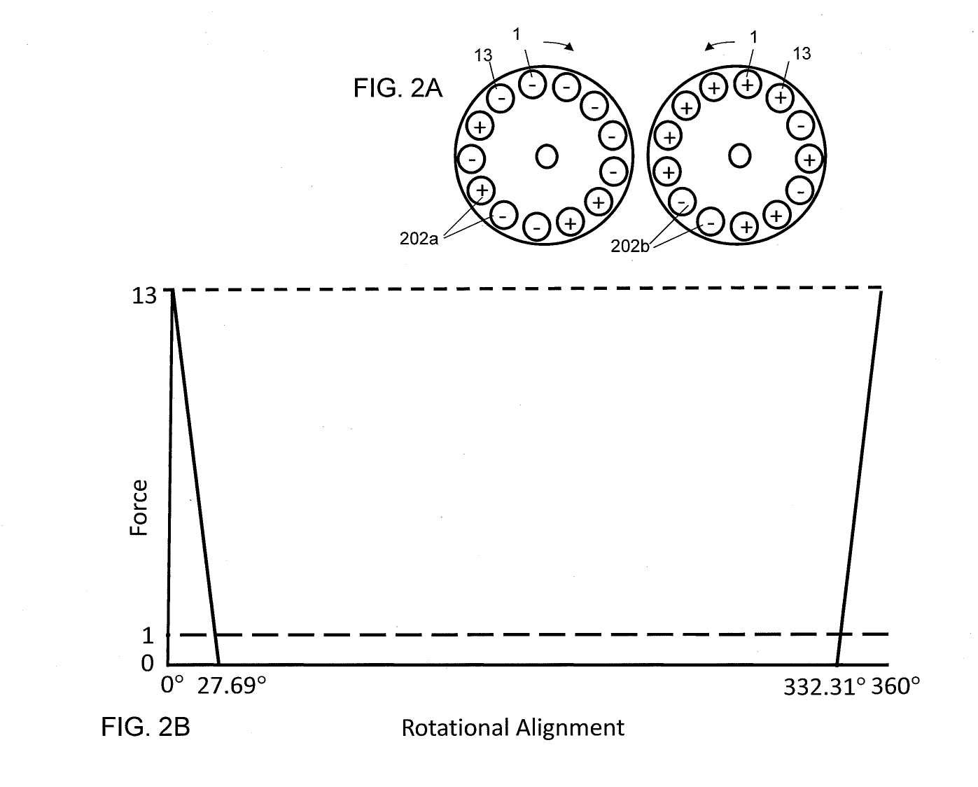

FIG. 2A depicts an exemplary first magnetic structure having thirteen magnetic sources having a first polarity pattern corresponding to cyclic implementation of a Barker 13 code and an exemplary second magnetic structure having thirteen magnetic sources having a second polarity pattern that is complementary to the first polarity pattern. Specifically, the first magnetic structure 202a has a first polarity pattern beginning at a magnet 1 that goes clockwise and ends at a magnet 13, and the second magnetic structure 202b has a second polarity pattern beginning a magnet 1 that goes counterclockwise and ends at a magnet 13.

FIG. 2B depicts the cyclic correlation function of the first magnetic structure rotating relative to the second magnetic structure where the peak occurs when each of the magnets of the first magnetic structure is aligned with respective complementary magnets of the second magnetic structure.

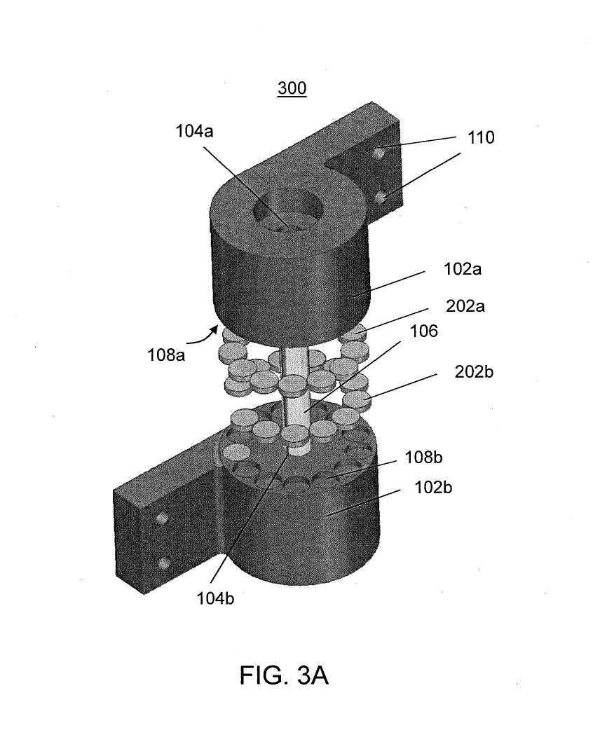

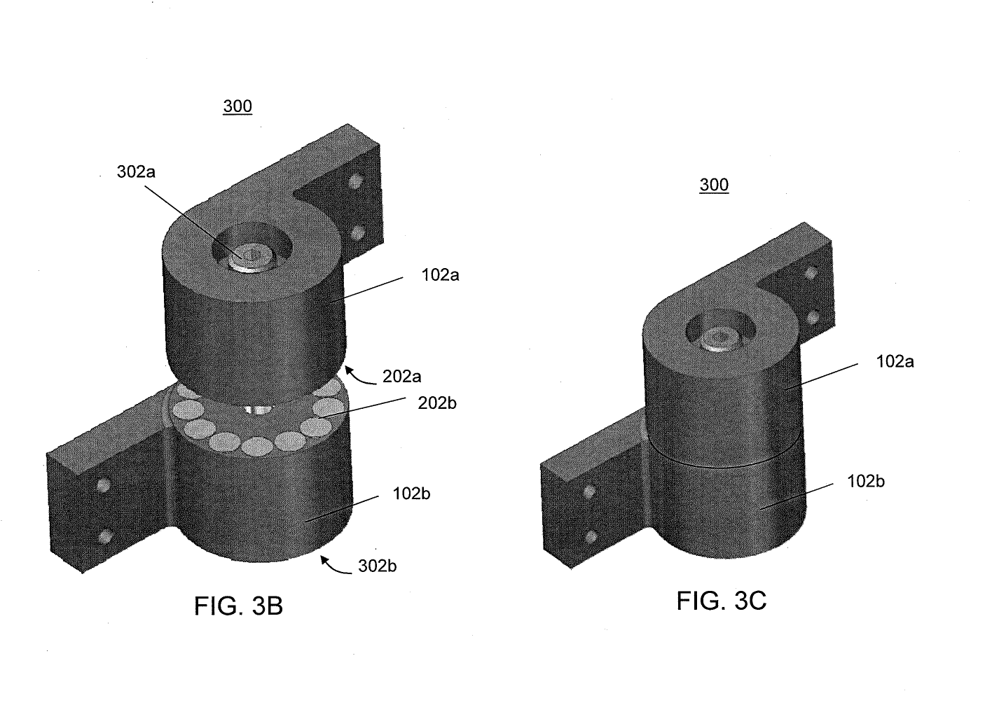

FIGS. 3A-3C depict assembly of an exemplary magnetic hinge system 300. Referring to FIG. 3A, a first component 102a and a second component 102b have respective holes 104a 104b for receiving an axle 106. They also have respective holes 108a 108b for receiving first and second magnetic structures 202a 202b each comprising 13 magnets. The magnets may be glued into the holes 108a 108b. The first and second components also have holes 110 for attaching them to two objects. Optionally, a low friction interface can be provided between the first and second magnetic structure 202a 202b. A low friction interface could be provided by a layer of a low friction material such as Teflon that can be placed on either or both of the first and second magnetic structures. Various other well-known approaches for providing a low friction interface can be used such as placing a spacer ring around the axle that prevents contact of the two magnetic structures or bearings.

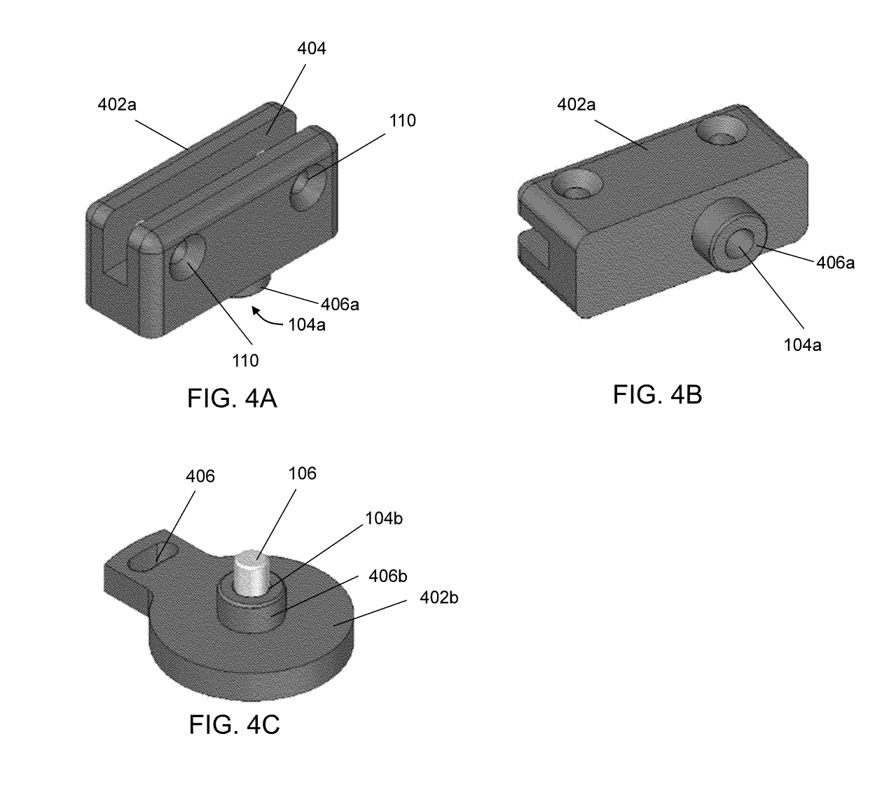

FIGS. 4A and 4B depict provide two views of another exemplary first component 402a that has a first circular peg 406a having a first hole 104a for receiving an axle 106, where a first ring shaped magnetic structure (not shown) can be placed such that the first circular peg 406a is inside the hole in the center of the first magnetic structure. The first component is configured with a U-channel 404 for accepting a portion of an object (not shown), for example a glass door, and has holes for inserted screws that secure the first component 402a to the object. FIG. 4C also depicts another exemplary second component 402b that has a second circular peg 406b having a second hole 104b for receiving the axle 106, where a second ring shaped magnetic structure (not shown) can be placed such that the second circular peg 406b is inside the hole in the center of the second magnetic structure.

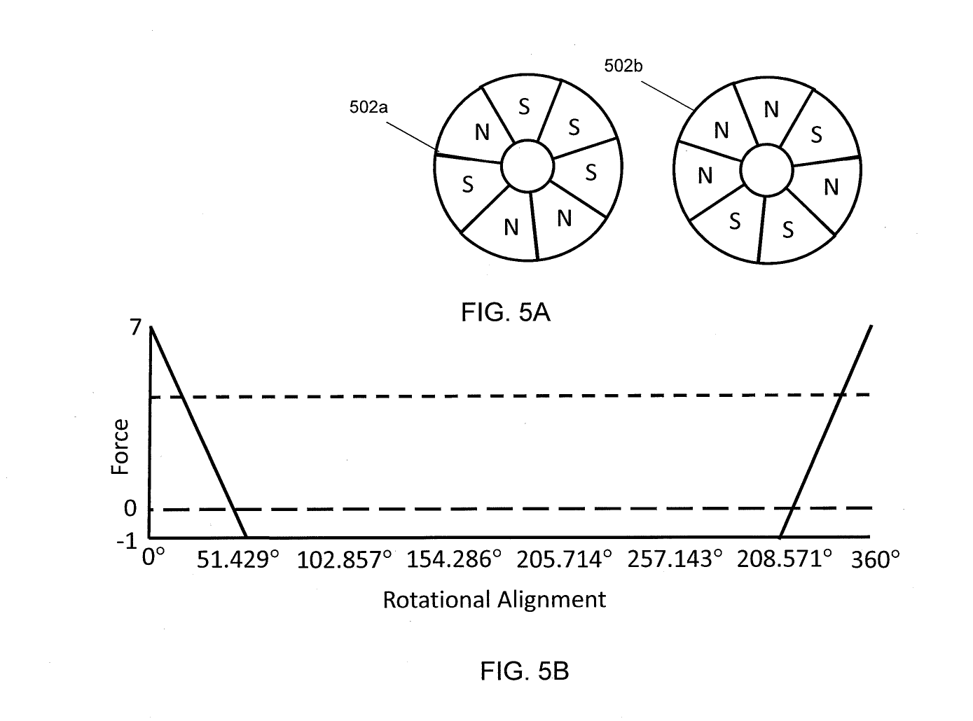

FIG. 5A depicts a top view of a first ring-shaped magnetic structure 502a having first magnetic source regions having a first polarity pattern in accordance with a Barker 7 code and a second ring-shaped magnetic structure 502b having second magnetic source regions having a second polarity pattern that is complementary to the first polarity pattern.

FIG. 5B depicts the cyclic correlation function of the Barker 7 code.

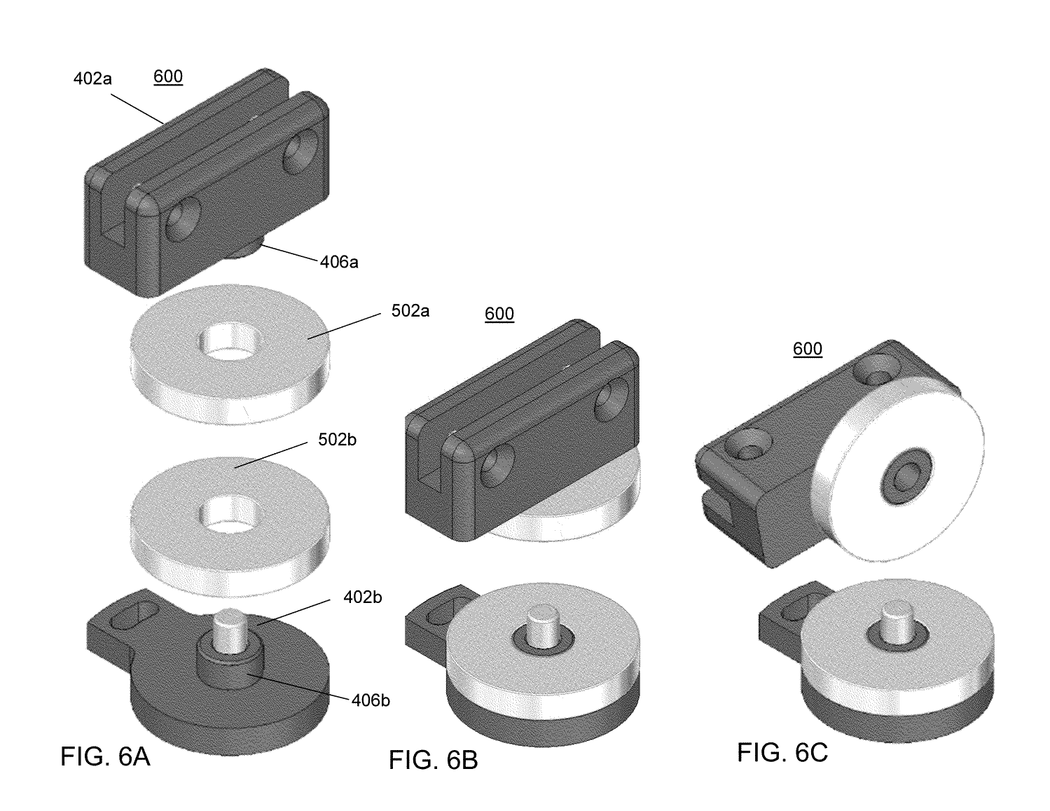

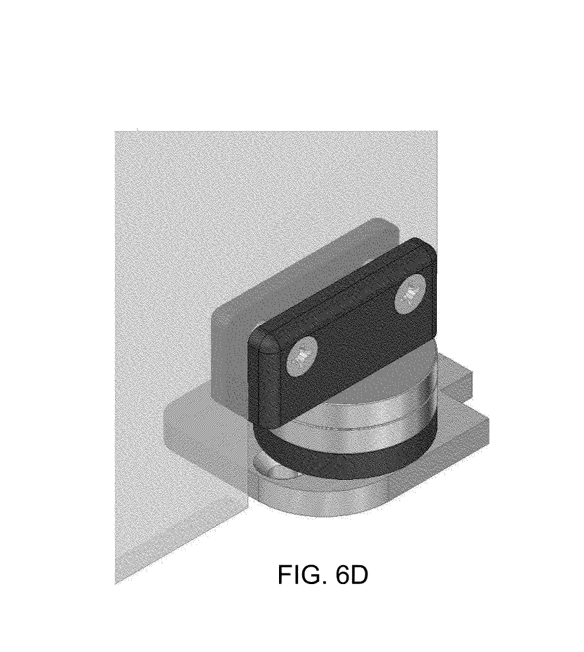

FIGS. 6A-6D depicts assembly of another exemplary magnetic hinge system 600 in accordance with the invention. Referring to FIG. 6A, a first magnetic structure 502a is placed such that the first peg 406a of the first component 402a is inserted inside the hole of the first magnetic structure 502a. Optionally, a first shunt plate (not shown) is placed on top of the first magnetic structure 502a prior to the first circular peg 406a being placed into the hole of the first magnetic structure. A second magnetic structure 502b is placed such that the second circular peg 406b is placed inside the hole of the second magnetic structure 502b. Optionally, a second shunt plate (not shown) is placed beneath the second magnetic structure 502a prior to the second circular peg 406b being placed into the hole of the second magnetic structure. When fully assembled the axle 506 extends into the holes 104a 104b of the first and second components 402a 402b, whereby the axle enables the first component to rotate relative to the second component.

Optionally, a low friction interface can be provided between the first and second magnetic structures 502a 502b. A low friction interface could be provided by a layer of a low friction material such as Teflon that can be placed on either or both of the first and second magnetic structures 502a 502b. Various other well-known approaches for providing a low friction interface can be used such as placing a spacer ring around the axle that prevents contact of the two magnetic structures. Under one arrangement either the first peg 406a is taller than thickness of the first magnetic structure 502a or the second circular peg 406b 406a is taller than thickness of the first magnetic structure 502b thereby providing a spacing between the first and second magnetic structures.

As with the first exemplary magnetic hinge system 300, the first and second magnetic structures 402a 402b can be assembled in the magnetic hinge system 600 such that a complementary alignment position corresponds to a desired rotational position of two attached objects.

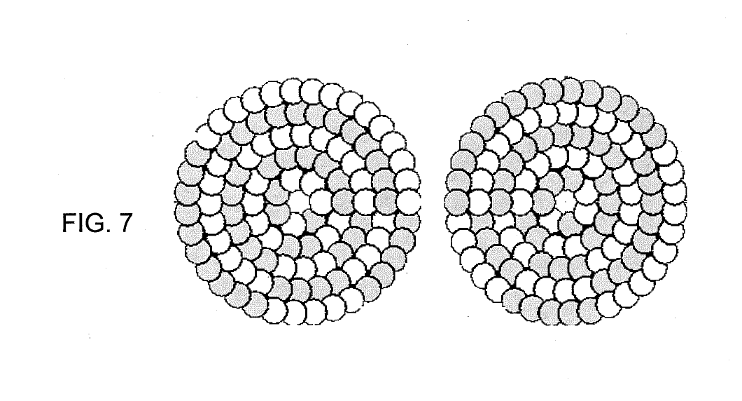

FIG. 7 depicts exemplary polarity patterns for printed magnetic sources (i.e., maxels) into complementary ring magnet structures in accordance with a cyclic implementation of a Barker 7 code. As seen in FIG. 7, the spatial frequency of overlapping printed maxels of each concentric circle can be selected such that the entire face of the magnet is covered. The maxel pattern in the center circle of the magnet has a single maxel representing each symbol of the Barker 7 code. The number of maxels per symbol of the concentric circles then increases radially outward where the ratio between Barker symbols remains ratio-metrically proportional. As shown, the polarity of every other concentric ring is also reversed, which increases the total force exerted by the magnet pair.

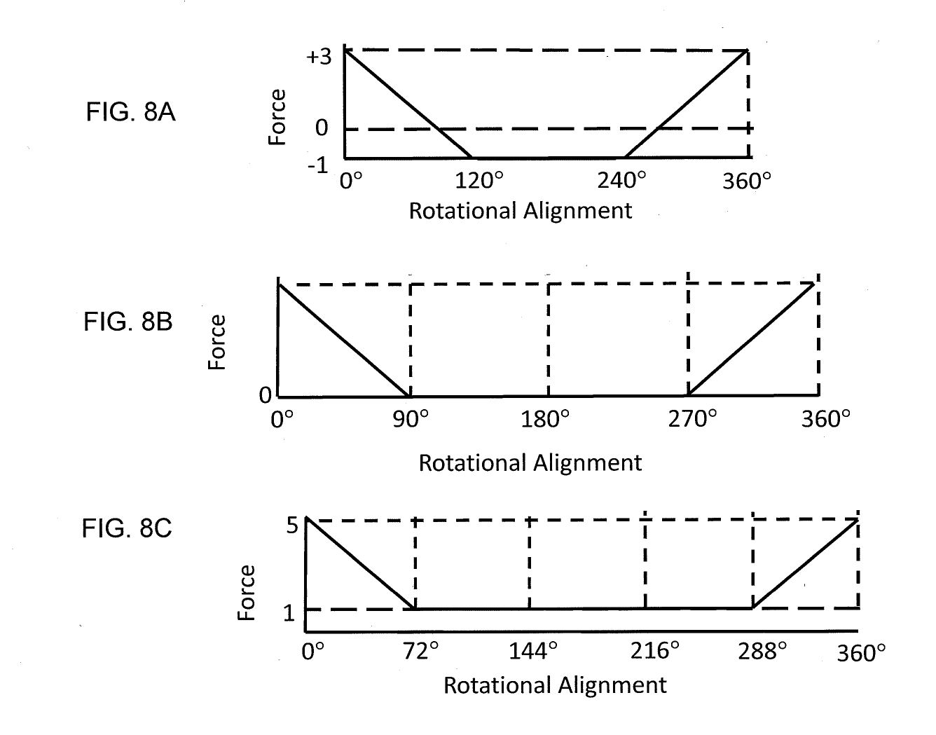

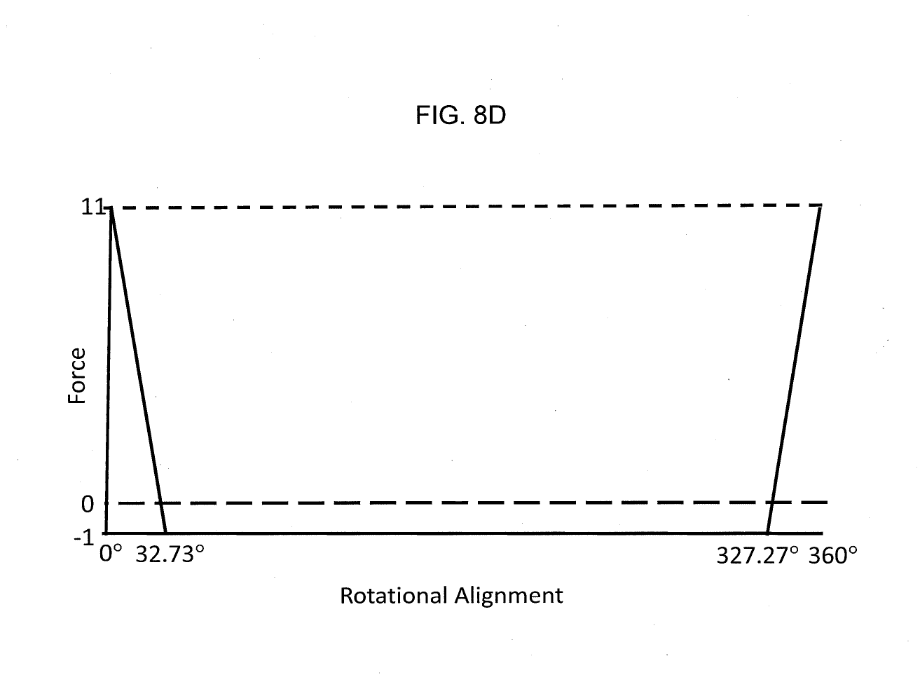

FIG. 8A depicts the cyclic correlation function of complementary magnetic structures having polarity patterns in accordance with a Barker 3 code.

FIG. 8B depicts the cyclic correlation function of complementary magnetic structures having polarity patterns in accordance with a Barker 4 code.

FIG. 8C depicts the cyclic correlation function of complementary magnetic structures having polarity patterns in accordance with a Barker 5 code.

FIG. 8D depicts the cyclic correlation function of complementary magnetic structures having polarity patterns in accordance with a Barker 11 code.

Although the examples provided above were based on a Barker 13 code and a Barker 7 code, any of the other Barker codes can be used in accordance with the present invention. Moreover pseudorandom codes can be used as well as other such codes, as has been previously disclosed.

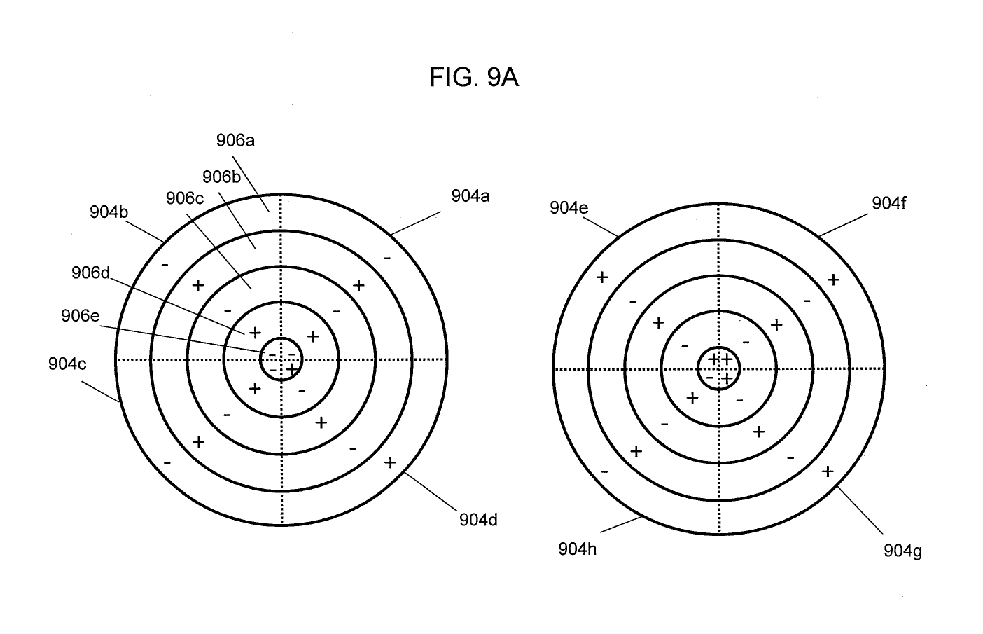

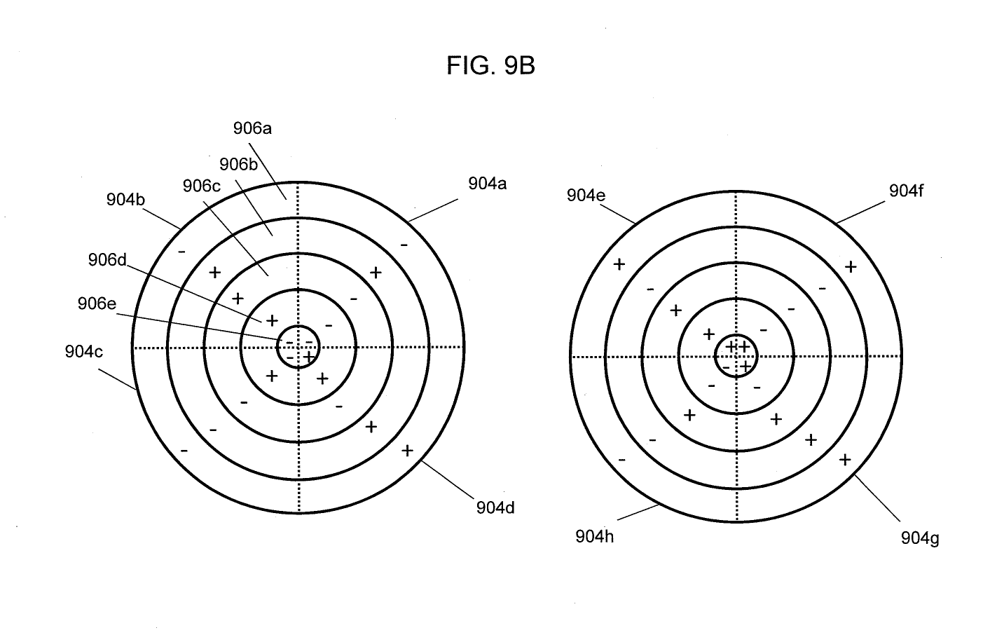

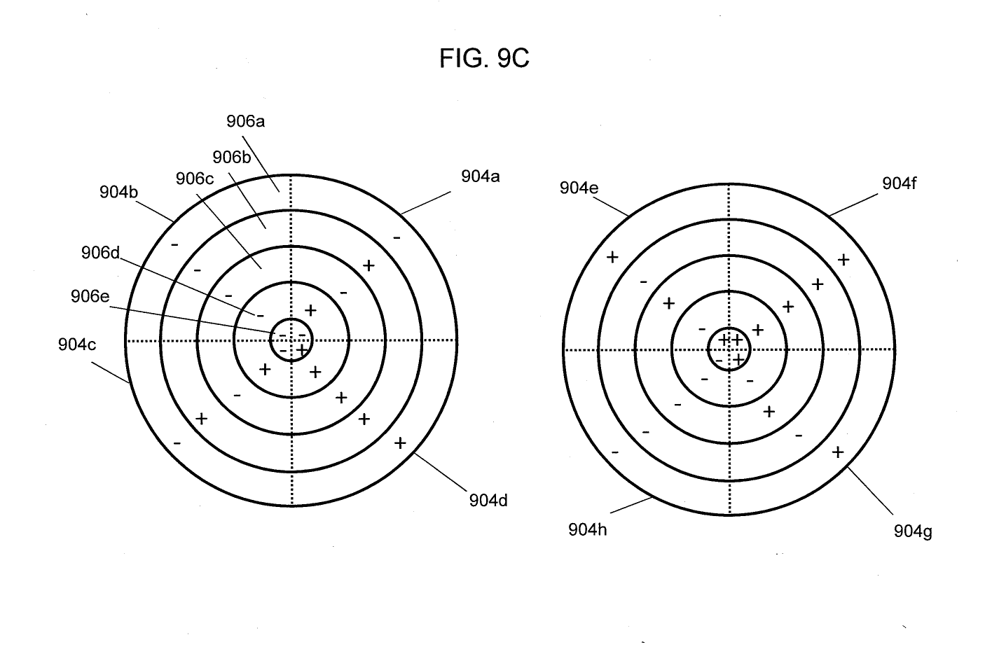

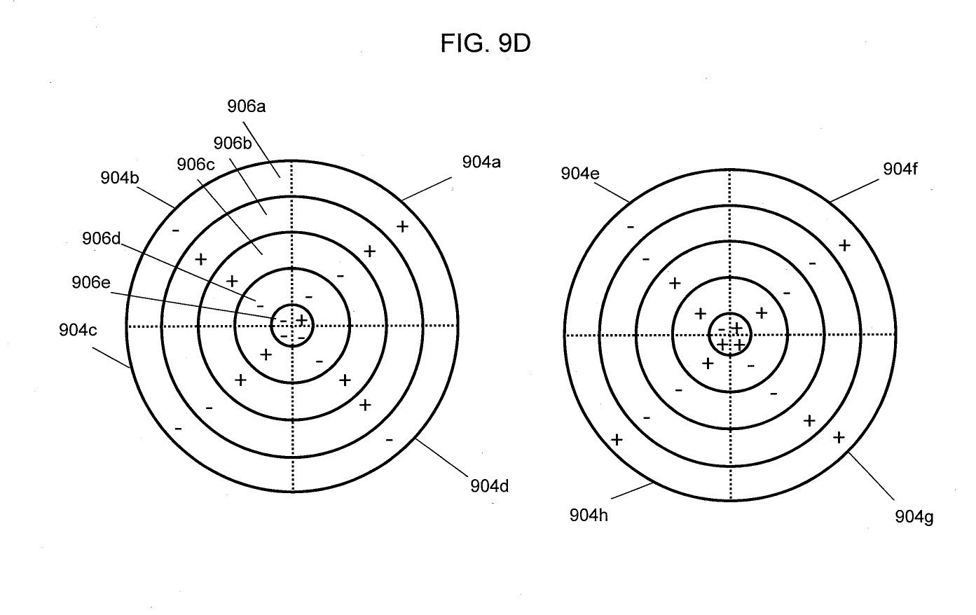

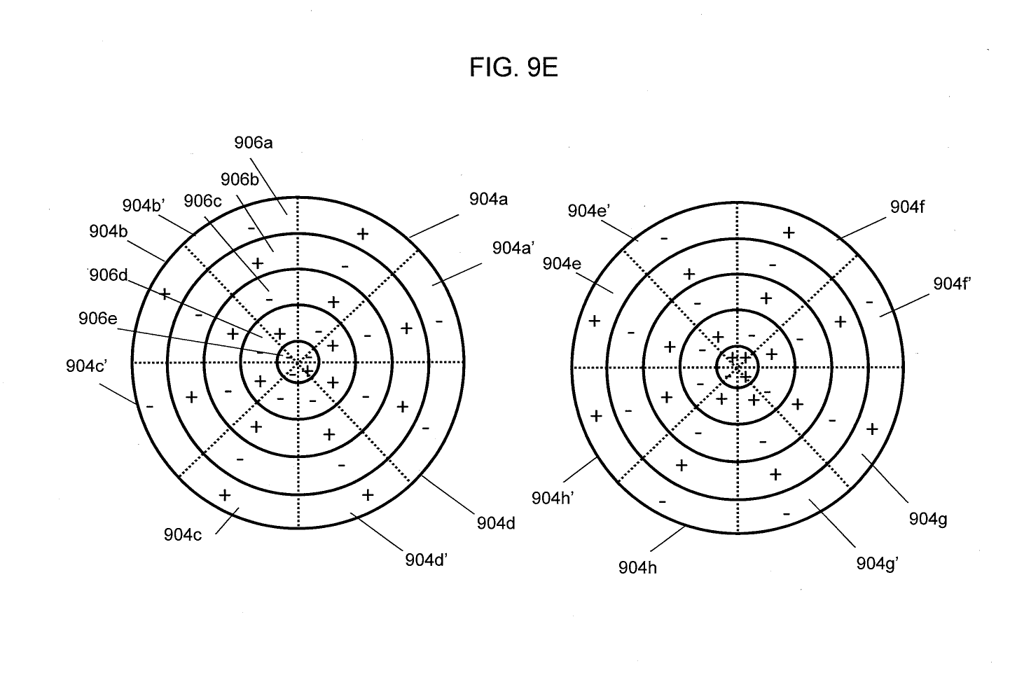

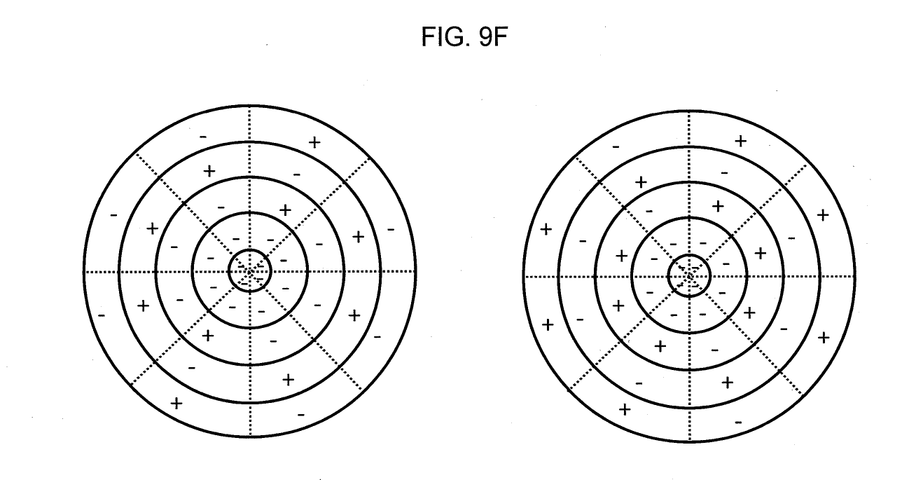

FIG. 9A depicts complementary Barker 4 coded magnetic structures where each ‘symbol’ of the Barker 4 code corresponds to alternating polarity arc segments that together form five concentric Barker 4 coded circles 902a-902e. One skilled in the art will recognize that increasing or decreasing the number of concentric circles controls the amount of tensile forces produced and the throw of the two magnetic structures.

FIG. 9B depicts exemplary magnetic structure polarity pattern designs where the starting point of the Barker 4 code sequence is rotated 90° with each successive concentric circle 902a-902e. By rotating the starting points of the circles, the locations where attract forces are occurring vs. where repel forces are occurring can be distributed, where it should be understood that prior to such rotation that between 90° and 270° half of the two magnetic structures would be in a repel state and the other half would be in an attract state. By rotating where the Barker codes start the net magnetic behavior stays the same but the locations of attract and repel forces can be distributed differently, where the number of possible combinations depends on the code length (e.g., 4) and the number of concentric circles used.

FIG. 9C shifts the starting point for each Barker 4 pattern 180 degrees for each odd concentric circle. This design results in two opposing quadrants of opposite polarity and two opposing quadrants having the same alternating polarity pattern.

FIG. 9D shifts the odd polarity quadrant 180 degrees with each circle and reverses the polarity of the third and fourth circles.

FIG. 9E illustrates how the arc segments of each quadrant can be subdivided into alternating polarity portions where increasing the number of portions per arc segments increases the tensile force, decreases the throw, and increases the rotational shear force (or torque) required to turn one magnetic structure relative to the other.

FIG. 9F illustrates how portions of the two magnetic structures can be used to provide a bias force. As shown, the outer three circles each have two cyclic Barker 4 code modulos and the inner three circles produce a repel bias force regardless of rotation.

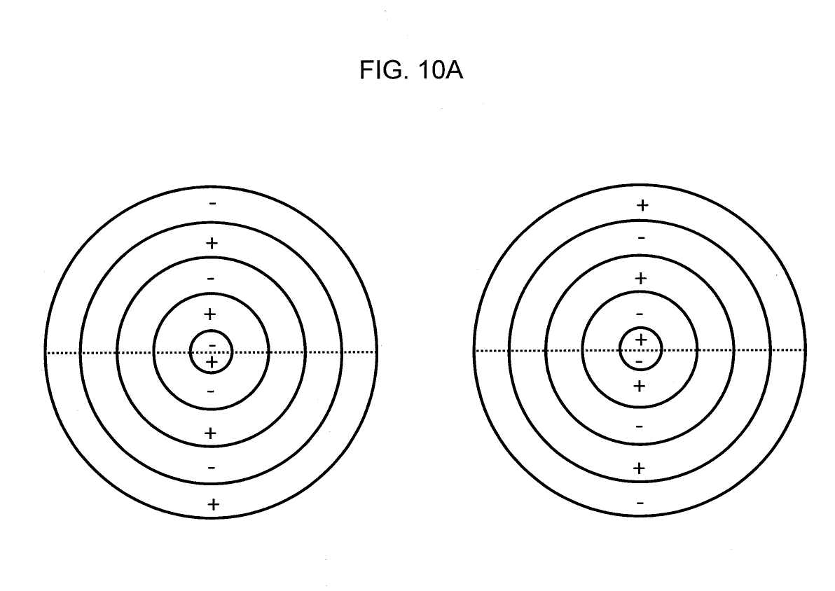

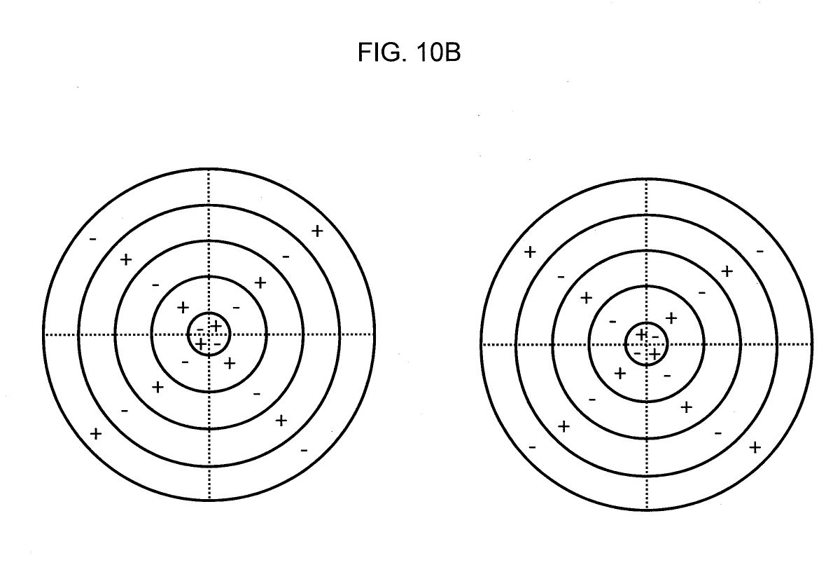

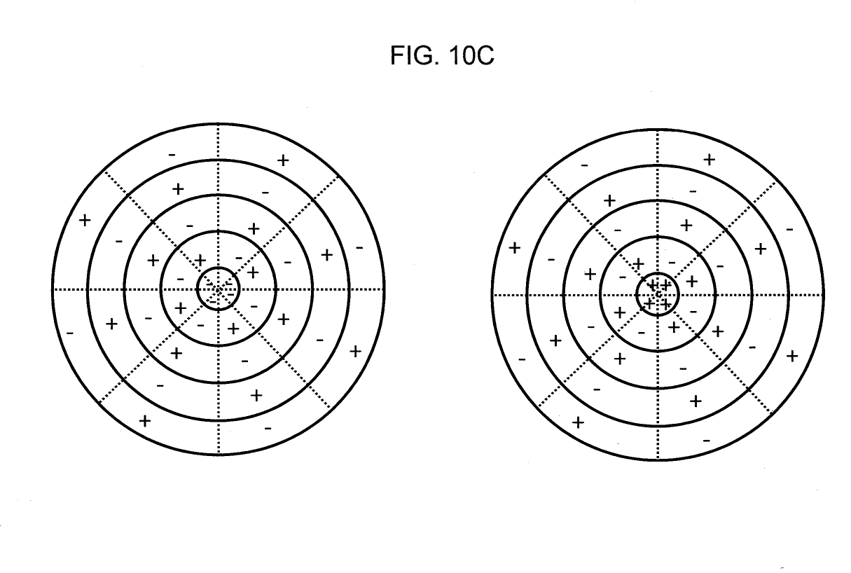

FIG. 10A depicts complementary magnetic structures comprising two halves of alternating polarity arc segments. This design will transition from a peak attract force at a peak attract force alignment position to a substantially zero force at =/−90° and will transition from a substantially zero force at +/−90° to a peak repel force at a peak repel force alignment position at +/−180°.

FIG. 10B depicts complementary magnetic structure comprising four alternating polarity quadrants of alternating polarity arc segments. This design will transition from a peak attract force at a peak attract force alignment position to a substantially zero force at =/−45° and will transition from a substantially zero force at +/−45° to a peak repel force at a peak repel force alignment position at +/−90°, will transition from a peak repel force at +/−45° to substantially zero force at +/−135°, and will transition from a substantially zero force to a attract force at +/−180°.

FIG. 10C depicts complementary magnetic structures where the outer four circles comprise eight alternating polarity octants of alternating polarity arc segments and inner most circles that provide an attract bias force regardless of rotational alignment.

One skilled in the art will recognize that the correlation functions in this disclosure are idealized, but illustrate the main principle and primary performance. The curves show performance assuming equal magnetic source size, shape, and strength and equal distance between corresponding magnetic sources. For simplicity, the plots only show discrete integer positions and interpolate linearly. Actual force values may vary due to various factors such as diagonal coupling of adjacent magnetic sources, magnetic source shape, spacing between magnetic sources, properties of magnetic materials, intrinsic attraction forces, etc. The curves also assume equal attract and repel forces for equal distances. Such forces may vary considerably and may not be equal. One skilled in the art will also understand that combinations of magnetic sources of different sizes, shapes, field strengths, spacings, and magnetic materials can be used to practice the invention.

While particular embodiments of the invention have been described, it will be understood, however, that the invention is not limited thereto, since modifications may be made by those skilled in the art, particularly in light of the foregoing teachings.

1. A magnetic hinge system, comprising:
a first component associated with a first object, said first component comprising:
a first hole; and
a first magnetic structure having a first plurality of magnetic source regions having a first polarity pattern;
a second component associated with a second object, said second component comprising:
a second hole; and
a second magnetic structure having a second plurality of magnetic source regions having a second polarity pattern complementary to said first polarity pattern; and
an axle, wherein said axle can be inserted into said first hole and said second hole such that the first and second magnetic structures face each other across an interface boundary, wherein said first polarity pattern and said second polarity pattern are in accordance with a cyclic implementation of a code of length N, wherein said code has a cyclic correlation function having a single peak and a plurality of off peaks per code modulo.

2. The magnetic hinge system of claim 1, wherein said magnetic hinge system is configured to have low friction between the first and second components.

3. The magnetic hinge system of claim 1, wherein said first and second polarity patterns are irregular polarity patterns.

4. The magnetic hinge system of claim 1, wherein said first and second magnetic structures produce a peak attract force when in a complementary rotational alignment position.

5. The magnetic hinge system of claim 4, wherein said complementary rotational alignment position corresponds to a desired alignment of said first component and said second component.

6. The magnetic hinge system of claim 4, wherein said complementary rotational alignment position corresponds to a closed position of door.

7. The magnetic hinge system of claim 1, wherein said first and second magnetic structures produce an off-peak force that is an attract force less than the peak attract force when the male component has been rotated relative to the female component plus or minus 360/N degrees from the complementary rotational alignment position and said cyclic implementation of said code includes only one code modulo of said code.

8. The magnetic hinge system of claim 1, wherein said first and second magnetic structures produce an off-peak force that is a substantially zero force when the male component has been rotated relative to the female component plus or minus 360/N degrees from the complementary rotational alignment position and said cyclic implementation of said code includes only one code modulo of said code.

9. The magnetic hinge system of claim 1, wherein said first and second magnetic structures produce an off-peak force that is a repel force when the male component has been rotated relative to the female component plus or minus 360/N degrees from the complementary rotational alignment position and said cyclic implementation of said code includes only one code modulo of said code.

10. The magnetic hinge system of claim 1, wherein said code is a Barker code.

11. The magnetic hinge system of claim 1, wherein each symbol of said code is implemented with one of a region having a first polarity or a region having a second polarity.

12. The magnetic hinge system of claim 1, wherein each symbol of said code is implemented with an irregular polarity pattern.

13. The magnetic hinge system of claim 1, wherein each symbol of said code is a Barker code.

14. The magnetic hinge system of claim 1, wherein each symbol of said code is implemented with alternating polarity regions.

15. The magnetic hinge system of claim 14, wherein one polarity region is rotated relative to another polarity region.

16. The magnetic hinge system of claim 14, wherein polarities of opposing regions of the first and second magnetic structures are exchanged.

17. The magnetic hinge system of claim 1, wherein said first component is integrated into said first object.

18. The magnetic hinge system of claim 1, wherein said second component is integrated into said second object.

19. The magnetic hinge system of claim 1, wherein at least one of said first magnetic structure or said second magnetic structure is ring shaped.

20. The magnetic hinge system of claim 1, wherein at least one of said first magnetic structure or said second magnetic structure comprises a plurality of discrete magnets.
